(19) United States
(12) Patent Application Publication
(10) Pub. No.: US 2004/0122651 A1
(43) Pub. Date: Jun. 24, 2004

(54) Apparatus and method for ethernet emulation in a 3RD generation wireless mobile station

(75) Inventor: Sudhindra P. Herle, Plano, TX (US)

Correspondence Address: Docket Clerk, P.O. Drawer 800889, Dallas, TX, 75380, US

(73) Assignee: SAMSUNG ELECTRONICS Co., LTD, Suwon-city (KR)

(21) Appl. No.: 10/328,052

(22) Filed: Dec. 23, 2002

(51) Int. Cl. G06F 9/455

(52) U.S. Cl. 703/27

(57) ABSTRACT

An apparatus for use in a wireless access terminal capable of accessing a 3G wireless network. The apparatus enables a host processing system to access the 3G wireless network using the wireless access terminal. The apparatus comprises: 1) a physical media dependent layer (PMDL) interface capable of transferring data between the wireless access terminal and the host processing system; and 2) an Ethernet emulation controller capable of communicating with the host processing system via the PMDL interface, wherein the Ethernet emulation controller emulates the operation of an Ethernet device adapter to thereby exchange data with the host processing system via an Ethernet protocol.

### TECHNICAL FIELD OF THE INVENTION

The present invention is directed generally to wireless communication systems and, more specifically, to an apparatus and method for emulating an Ethernet adapter in a 3G wireless mobile station.

### BACKGROUND OF THE INVENTION

In order to increase the wireless market to the greatest extent possible, wireless service providers and wireless equipment manufacturers constantly seek new ways to make wireless equipment and services as convenient, user-friendly, and affordable as possible. To that end, wireless service providers are upgrading the existing network infrastructure in order to deploy third generation (3G) wireless systems and services. The principle attractions of 3G systems are new non-voice services and higher data speeds. A number of standards have been proposed for 3G networks, including, for example, the Universal Mobile Telecommunication System (UMTS) standard. However, a key feature of all proposed 3G networks is a high-speed, always-on digital connection between the wireless network and each wireless access terminal.

Consumers have been able to use cellular telephones (or similar wireless access terminals) to provide Internet connections to personal computers, especially lap top computers. This is typically accomplished by connecting the serial port of a host personal computer (PC) to the serial port of a cellular phone using a cable. The cellular phone acts as an analog modem for the host PC. The operator (or the host PC) uses the cell phone to dial the phone number of a dial-up connection to an Internet service provider. Once a connection was established, the host PC is able to browse the Internet as if the host PC was connected by an internal modem to a land line.

3G cell phones and other 3G wireless access terminals will also be able to provide an Internet connection to a laptop computer or other host processing system. However, since a 3G-capable device is able to achieve a high data rate, using the 3G-capable device like an analog modem is an inefficient use of the resources of the wireless network. Among other things, operating a 3G phone like an analog modem entails unnecessary header and trailer encapsulation of IP frames. Also, the 3G phone establishes a conventional call connection to an Internet service provider (ISP). This is an always-on connection that ties up a radio channel for that cell phone, even if data is not being transferred to or from the host PC.

Therefore, there is a need in the art for improved 3G wireless devices that may be connected to a host processing system in order to provide access to a data network. In particular, there is a need for 3G wireless access terminals that can provide a high-speed always-on digital data connection between a host PC and the Internet via a public wireless network.

### SUMMARY OF THE INVENTION

The present invention enables a 3G capable wireless access terminal (e.g., a UMTS cell phone) to appear like an Ethernet adapter to the operating system (e.g., Windows, Linux) of a host processing system (e.g., laptop PC). The present invention also enables the wireless access terminal to emulate the always-on nature of an Ethernet device.

The present invention comprises a 3G wireless access terminal, such as a 3G cell phone, that has a Universal Serial Bus (USB) port (or similar data link) for host connectivity. A key feature of the present invention is making the cell phone (or other wireless access terminal) appear to be a USB-over-Ethernet device. According to an exemplary embodiment, the present invention comprises a USB device controller and other firmware on the cell phone and appropriate device drivers on the host PC (such as Windows, Linux). A USB cable provides connectivity between the host PC and the 3G cell phone.

In alternate embodiments of the present invention, the USB connection between the host PC and the 3G wireless access terminal may be replaced with a similar suitable connection, such as a Firewire connection or a Bluetooth wireless connection. The precise physical connection used between the 3G wireless access terminal and the host PC is not critical. However, in all cases, the novelty is the ability to make a 3G wireless access terminal behave like an Ethernet device. Thus, the invention is a simple and effective way to use a 3G cell phone (or other wireless access terminal) with a host PC to get the high bandwidth advantages of a 3G connection.

To address the above-discussed deficiencies of the prior art, it is a primary object of the present invention to provide, for use in a wireless access terminal capable of accessing a 3G wireless network, an apparatus for enabling a host processing system to access the 3G wireless network. According to an advantageous embodiment of the present invention, the apparatus comprises: 1) a physical media dependent layer (PMDL) interface capable of transferring data between the wireless access terminal and the host processing system; and 2) an Ethernet emulation controller capable of communicating with the host processing system via the PMDL interface, wherein the Ethernet emulation controller emulates the operation of an Ethernet device adapter to thereby exchange data with the host processing system via an Ethernet protocol.

According to one embodiment of the present invention, the Ethernet emulation controller is capable of communicating with the wireless network via a wireless transceiver of the wireless access terminal.

According to another embodiment of the present invention, the Ethernet emulation controller is further capable of emulating the operation of a Dynamic Host Configuration Protocol (DHCP) server to the host processing system.

According to still another embodiment of the present invention, the PMDL interface comprises a wireline interface.

According to yet another embodiment of the present invention, the PMDL interface comprises a wireless interface.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates selected portions of a communication network in which a cellular phone emulates an Ethernet adapter according to the principles of the present invention;

FIG. 2 illustrates an exemplary cellular phone in greater detail according to one embodiment of the present invention;

FIG. 3 illustrates the interoperation of selected functional blocks in the cellular phone; and

FIG. 4 illustrates the interoperation of selected network communication layers in the host personal computer and the exemplary cell phone according to the principles of the present invention.

### DETAILED DESCRIPTION OF THE INVENTION

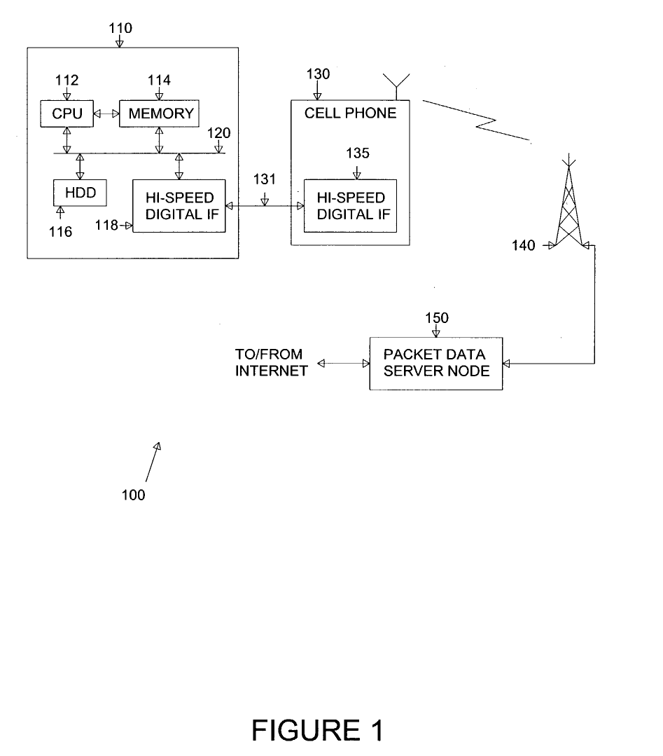

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless mobile station.

FIG. 1 illustrates selected portions of communication network 100, in which cell phone 130 emulates an Ethernet adapter according to the principles of the present invention. Communication network 100 comprises host processing system 110, cell phone 130, base station 140, and packet data server node (PDSN) 150. According to an exemplary embodiment of the present invention host processing system 110 is a personal computer (PC) comprising central processing unit (CPU) 112, memory 114 (e.g., RAM), hard-disk drive (HDD) 116, high speed digital interface (IF) 118, and system bus 120.

Host processing system 110 can access base station 140 of a wireless network via cell phone 130. High-speed digital interface 118 in host processing system 110 communicates with a similar high-speed digital interface 135 in cell phone 130 via data link 131. Depending on the implementation, data link 131 may be a wireline link or a wireless link. According to the principles of the present invention, cell phone 130 emulates an Ethernet device adapter to host processing system 110. Once an Ethernet connection is established between host processing system 110 and cell phone 130, host processing system 110 may access the Internet via base station 140 and PDSN 150.

High-speed digital interfaces 118 and 135 may be any type of short-range wireline or wireless connections that can support an Ethernet link between host processing system 110 and cell phone 130. For example, in a first embodiment of the present invention, high-speed digital interfaces 118 and 135 may comprise USB interfaces that communicate across a USB cable. In a second embodiment of the present invention, high-speed digital interfaces 118 and 135 may comprise Firewire interfaces that communicate across a Firewire cable. In a third embodiment of the present invention, high-speed digital interfaces 118 and 135 may comprise Bluetooth-capable wireless transceivers that communicate across a radio link.

Those skilled in the art will understand that host processing system 110 and cell phone 130 are selected only for the purpose of illustrating the operation of the present invention. It will be appreciated by those skilled in the art that in other embodiments, host processing system 110 need not be a personal computer (PC) and cell phone 130 may be replaced by a number of different 3G wireless access terminals. For example, in an alternate embodiment, host processing system 110 may be a router or switch that has a plurality of USB interfaces for interconnecting a number of network devices (e.g., a PC, a printer, a scanner, etc.) to cell phone 130. Similarly, cell phone 130 may be replaced by a 3G-capable hand-held computer, such as a Palm or Handspring computer. Generally speaking, cell phone 130 represents any 3G wireless access terminal and host processing system 110 represents any type of data device that can access a network via an Ethernet connection.

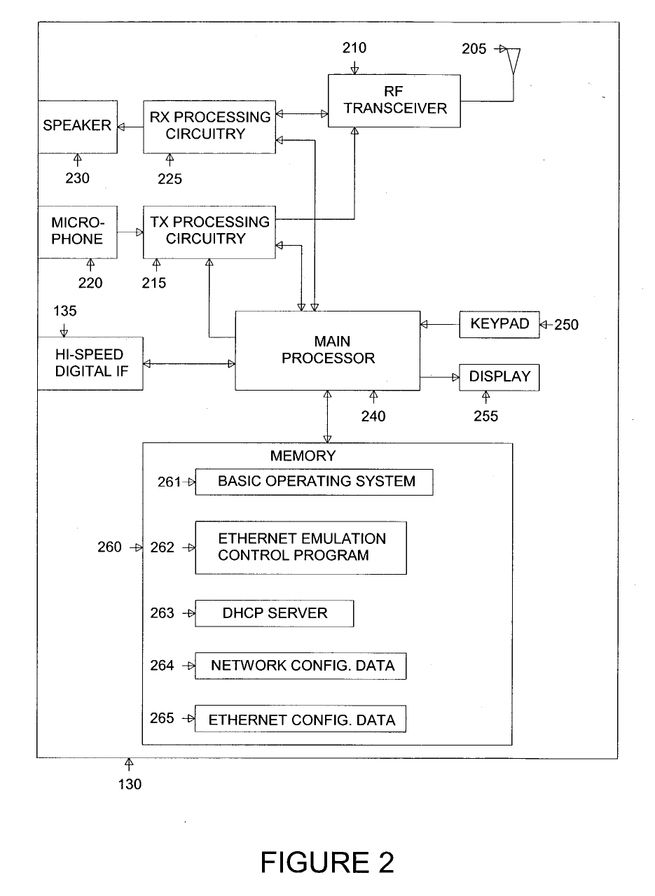

FIG. 2 illustrates exemplary cell phone 130 in greater detail according to one embodiment of the present invention. Cell phone 130 comprises antenna 205, radio frequency (RF) transceiver 210, transmit (TX) processing circuitry 215, microphone 220, and receive (RX) processing circuitry 225. Cell phone 130 also comprises speaker 230, main processor 240, high speed digital interface 135, keypad 250, display 255, and memory 260. Memory 260 stores basic operating system (OS) program 261, Ethernet emulation control program 262, Dynamic Host Configuration Protocol (DHCP) server program 263, network configuration data field 264, and Ethernet configuration data field 265.

Radio frequency (RF) transceiver 210 is a 3G wireless transceiver that receives from antenna 205 an incoming RF signal transmitted by a base station of wireless network 100. Radio frequency (RF) transceiver 210 down-converts the incoming RF signal to produce an intermediate frequency (IF) or a baseband signal. The IF or baseband signal is sent to receiver (RX) processing circuitry 225 that produces a processed baseband signal by filtering, decoding, and/or digitizing the baseband or IF signal to produce a processed baseband signal. Receiver (RX) processing circuitry 225 transmits the processed baseband signal to speaker 230 (i.e., voice data) or to main processor 240 for further processing (e.g., web browsing).

Transmitter (TX) processing circuitry 215 receives analog or digital voice data from microphone 220 or other outgoing baseband data (e.g., web data, e-mail, interactive video game data) from main processor 240. Transmitter (TX) processing circuitry 215 encodes, multiplexes, and/or digitizes the outgoing baseband data to produce a processed baseband or IF signal. Radio frequency (RF) transceiver 210 receives the outgoing processed baseband or IF signal from transmitter (TX) processing circuitry 215. Radio frequency (RF) transceiver 210 up-converts the baseband or IF signal to a radio frequency (RF) signal that is transmitted via antenna 205.

In an advantageous embodiment of the present invention, main processor 240 is a microprocessor or microcontroller. Memory 260 is coupled to main processor 240. According to an advantageous embodiment of the present invention, part of memory 260 may comprise a random access memory (RAM) and another part of memory 260 may comprise a Flash memory, which acts as a read-only memory (ROM).

Main processor 240 executes basic operating system (OS) program 261 stored in memory 260 in order to control the overall operation of cell phone 130. In one such operation, main processor 240 controls the reception of forward channel signals and the transmission of reverse channel signals by radio frequency (RF) transceiver 210, receiver (RX) processing circuitry 225, and transmitter (TX) processing circuitry 215, in accordance with well-known principles.

Main processor 240 is capable of executing other processes and programs resident in memory 260. Main processor 240 can move data into or out of memory 260, as required by an executing process. Main processor 240 is also coupled to high-speed digital interface (IF) 135. High-speed digital IF 135 provides cell phone 130 with the ability to connect to external devices, such as host processing system 110.

Main processor 240 is also coupled to keypad 250 and display unit 255. The operator of cell phone 130 uses keypad 250 to enter data into cell phone 130. Display 255 may be a liquid crystal display capable of rendering text and/or at least limited graphics from web sites. Alternate embodiments may use other types of displays.

In accordance with the principles of the present invention, main processor 240 may execute Ethernet emulation control program 262 in order to emulate an Ethernet adapter over high-speed digital IF 135. For the purposes of discussion, it will be assumed that basic operating system program 261 is Windows and that high-speed digital interfaces 118 and 135 are USB interface cards. However, this should not be construed so as to limit the generality of the present invention. Also, it is assumed that cell phone 130 is not initially connected to host processing system 110.

When cell phone 130 is hot-plugged into host processing system 110, the USB drivers on host processing system 110 send configuration commands to the USB interface card in cell phone 130. When cell phone 130 responds to the USB device driver in host processing system 110, main processor 240, under control of Ethernet emulation control program 262, indicates that it is a Communications Device Class (CDC) device. At the same time, main processor 240 indicates the vendor ID and device ID to host processing system 110. Host processing system 110 uses the vendor ID and the device ID to select the correct device driver for the CDC device associated with cell phone 130.

Next, main processor 240 indicates to host processing system 110 that the Ethernet link is DOWN. Subsequently, main processor 240 establishes a 3G data call over the air interface to base station 140 and PDSN 150. As part of the 3G data call, main processor 240 receives an IP address, a netmask, Domain Name Server (DNS) information, and the like, from base station 140 of the wireless network. Main processor 240 stores this information in network configuration data field 264. As soon as this information is available, main processor 240 indicates to host processing system 110 that the Ethernet link is UP.

Since cell phone 130 appears to be an Ethernet device adapter to host processing system 110, host processing system 110 issues DHCP commands to obtain the IP address and other information. Under the control of DHCP server program 263, main processor 240 transmits the IP address, netmask, and DNS information obtained from the wireless network to host processing system 110. Thus, host processing system 110 get its own IP address.

If host processing system 110 is configured with a static IP address, then main processor 240 modifies the IP header as it traverses from the USB link (i.e., high-speed digital IF 135) to the air interface and vice-versa. The dynamic address given by the network is not given to host processing system 110.

Main processor 240 uses the Electronic Serial Number (ESN), or some other hardware key, of cell phone 130 along with its Public Land Mobile Network (PLMN) ID to generate two 48-bit Ethernet Medium Access Control (MAC) addresses, which are stored in Ethernet configuration data field 265. Main processor 240 uses one of the MAC addresses as its own MAC address (i.e., as understood by host processing system 110). The other MAC address is used for responding to Address Resolution Protocol (ARP) requests from host processing system 110. That is, when host processing system 110 issues ARP requests to resolve IP address to hardware address, main processor 240 responds with the second MAC address, thus indicating that the desired IP address can be reached via the USB link.

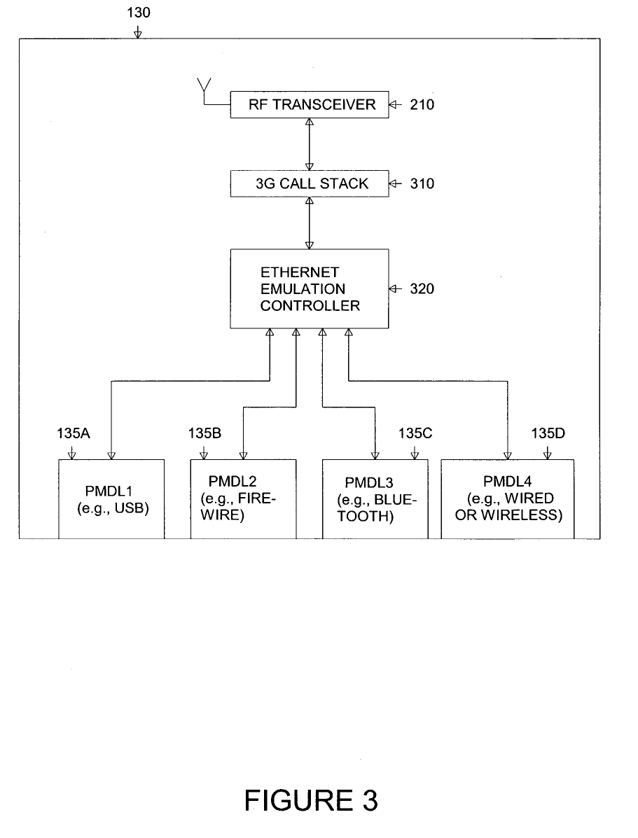

FIG. 3 illustrates the interoperation of selected functional blocks in cell phone 130. Ethernet emulation controller 320 represents main processor 240, Ethernet emulation control program 262, and DHCP server program 263. On the air interface side, Ethernet emulation controller 320 controls RF transceiver 210 via 3G call stack 310. 3G call stack 310 transfers outbound data packets from Ethernet emulation controller 320 to RF transceiver 210 and transfers inbound data packets from RF transceiver 210 to Ethernet emulation controller 320.

On the host processing system side, Ethernet emulation controller 320 emulates an Ethernet adapter in order to communicate with host processing system 110 via the physical media dependent layer (PMDL) of one or more high-speed digital interfaces 135A, 135B, 135C and 135D. In the illustrated embodiment, the physical media dependent layer (PMDL1) of high-speed digital interface 135A is a Universal Serial Bus (USB) layer, the physical media dependent layer (PMDL2) of high-speed digital interface 135B is a Firewire layer, the physical media dependent layer (PMDL3) of high-speed digital interface 135C is a wireless Bluetooth layer, and the physical media dependent layer (PMDL4) of high-speed digital interface 135D is some other conventional wireline or wireless layer. It is noted that high-speed digital interfaces 135A, 135B, 135C and 135D are shown for reference only. In most cases, due to the physical size limitations of cell phone 130, only one of high-speed digital interfaces 135A, 135B, 135C and 135D is likely to be implemented in cell phone 130.

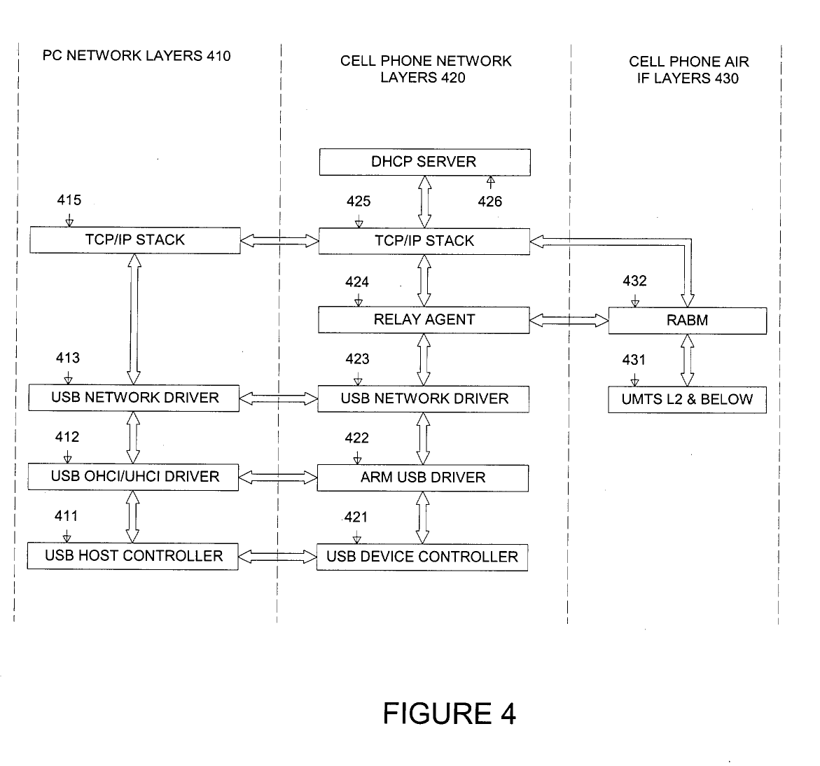

FIG. 4 illustrates the interoperation of selected network communication layers in the host personal computer and the exemplary cell phone according to the principles of the present invention. The illustrated network communication layers include personal computer (PC) network layers 410, cell phone network layers 420, and cell phone air interface (IF) layers 430. PC network layers 410 are the conventional Windows, USB, Network Driver Interface Specification (NDIS), and Transmission Control Protocol/Internet Protocol (TCP/IP) layers found in host processing system 110. PC network layers 410 comprise USB host controller layer 411, USB Open Host Controller Interface/Universal Host Controller Interface (OHCI/UHCI) driver 412, USB network driver 413, and TCP/IP stack layer 415.

Each one of PC network layers 410 has a corresponding layer in cell phone network layers 420, as indicated by the horizontal data flow arrows. Cell phone network layers 420 comprise USB device controller layer 421, ARM USB driver 422, USB network driver 423, relay agent layer 424, TCP/IP stack layer 425, and DHCP server layer 426. Relay agent layer 424 is required until an IP address is obtained from the wireless network. After that, the Ethernet packets are processed in a fast path directly from the USB driver to the air interface. USB device controller layer 421 and ARM USB driver 422 are conventional cell phone layers for controlling a USB interface. The present invention resides in the upper layers, namely USB network driver 423, relay agent layer 424, TCP/IP stack layer 425, and DHCP server layer 426. Cell phone air interface layers 430 are conventional air interface software layers in cell phone 130. Cell phone air interface layers 430 comprise UMTS L2 and below layers 431 and Radio Access Bearer Management (RABM) layer 432.

Although the present invention has been described in detail, those skilled in the art should understand that they can make various changes, substitutions and alterations herein without departing from the spirit and scope of the invention in its broadest form.

What is claimed is:

1. For use in a wireless access terminal capable of accessing a 3G wireless network, an apparatus for enabling a host processing system to access said 3G wireless network, said apparatus comprising:
a physical media dependent layer (PMDL) interface capable of transferring data between said wireless access terminal and said host processing system; and
an Ethernet emulation controller capable of communicating with said host processing system via said PMDL interface, wherein said Ethernet emulation controller emulates the operation of an Ethernet device adapter to thereby exchange data with said host processing system via an Ethernet protocol.

2. The apparatus as set forth in claim 1 wherein said Ethernet emulation controller is capable of communicating with said wireless network via a wireless transceiver of said wireless access terminal.

3. The apparatus as set forth in claim 2 wherein said Ethernet emulation controller is further capable of emulating the operation of a DHCP server to said host processing system.

4. The apparatus as set forth in claim 3 wherein said PMDL interface comprises a wireline interface.

5. The apparatus as set forth in claim 4 wherein said wireline interface comprises a Universal Serial Bus (USB) interface.

6. The apparatus as set forth in claim 4 wherein said wireline interface comprises a Firewire interface.

7. The apparatus as set forth in claim 3 wherein said PMDL interface comprises a wireless interface.

8. The apparatus as set forth in claim 7 wherein said wireless interface comprises a Bluetooth interface.

9. A wireless access terminal capable of accessing a 3G wireless network comprising:
a 3G-capable transceiver capable of communicating with said 3G wireless network via an air interface;
a physical media dependent layer (PMDL) interface capable of transferring data between said wireless access terminal and a host processing system associated with said wireless access terminal; and
an Ethernet emulation controller capable of communicating with said host processing system via said PMDL interface, wherein 11 said Ethernet emulation controller emulates the operation of an Ethernet device adapter to thereby exchange data with said host processing system via an Ethernet protocol.

10. The wireless access terminal as set forth in claim 9 wherein said Ethernet emulation controller is capable of communicating with said wireless network via said 3G-capable transceiver.

11. The wireless access terminal as set forth in claim 10 wherein said Ethernet emulation controller is further capable of emulating the operation of a DHCP server to said host processing system.

12. The wireless access terminal as set forth in claim 11 wherein said PMDL interface comprises a wireline interface.

13. The wireless access terminal as set forth in claim 12 wherein said wireline interface comprises a Universal Serial Bus (USB) interface.

14. The wireless access terminal as set forth in claim 12 wherein said wireline interface comprises a Firewire interface.

15. The wireless access terminal as set forth in claim 11 wherein said PMDL interface comprises a wireless interface.

16. The wireless access terminal as set forth in claim 15 wherein said wireless interface comprises a Bluetooth interface.

17. For use in a wireless access terminal capable of accessing a 3G wireless network, a method of enabling a host processing system to access the 3G wireless network comprising the steps of:
establishing a connection to the host processing system via a physical media dependent layer (PMDL) interface capable of transferring data between the wireless access terminal and the host processing system; and
receiving a configuration message from the host processing system; and
in response to receipt of the configuration message, transmitting a response message to the host processing system indicating that the wireless access terminal is an Ethernet device adapter to thereby establish an Ethernet connection for exchanging data with the host processing system.

18. The method as set forth in claim 17 further comprising the step of emulating the operation of a DHCP server to the host processing system.

19. The method as set forth in claim 18 wherein the PMDL interface comprises a wireline interface.

20. The method as set forth in claim 18 wherein the PMDL interface comprises a wireless interface.
